(19) United States
(12) Patent Application Publication
(10) Pub. No.: US 2002/0133499 A1
(43) Pub. Date: Sep. 19, 2002

(54) System and method for acoustic fingerprinting

(76) Inventors: Sean Ward, Alexandria, VA (US); Isaac Richards, Willoughby, OH (US)

Correspondence Address: William L. Feeney, Miles & Stockbridge, P.C., Suite 500, 1751 Pinnacle Drive, McLean, VA, 22102-3833, US

(21) Appl. No.: 09/931,859

(22) Filed: Aug. 20, 2001

Related U.S. Application Data
(60) Provisional application No. 60/275,029, filed on Mar. 13, 2001.

(51) Int. Cl. G06F 7/00

(52) U.S. Cl. 707/102

(57) ABSTRACT

A method for quickly and accurately identifying a digital file, specifically one that represents an audio file. The identification can be used for tracking royalty payments to copyright owners. A database stores features of various audio files and a globably unique identifier (GUID) for each file. Advantageously, the method allows a database to be updated in the case of a new audio file by storing its features and generating a new unique identifier for the new file. The audio file is sampled to generate a fingerprint that uses spectral residuals and transforms of Haar wavelets. Advantageously, any label used for the work is automatically updated if it appears to be in error.

### CROSS-REFERENCE TO RELATED APPLICATION

The present application claims the benefit of U.S. provisional application No. 60/275,029 filed Mar. 13, 2001. That application is hereby incorporated by reference.

### FIELD OF THE INVENTION

The present invention is related to a method for the creation of digital fingerprints that are representative of the properties of a digital file. Specifically, the fingerprints represent acoustic properties of an audio signal corresponding to the file. More particularly, it is a system to allow the creation of fingerprints that allow the recognition of audio signals, independent of common signal distortions, such as normalization and psycho acoustic compression.

### DESCRIPTION OF THE PRIOR ART

Acoustic fingerprinting has historically been used primarily for signal recognition purposes, in particular, terrestrial radio monitoring systems. Since these were primarily continuous audio sources, fingerprinting solutions were required which dealt with the lack of delimiters between given signals. Additionally, performance was not a primary concern of these systems, as any given monitoring system did not have to discriminate between hundreds of thousands of signals, and the ability to tune the system for speed versus robustness was not of great importance.

As a survey of the existing approaches, U.S. Pat. No. 5,918,223 describes a system that builds sets of feature vectors, using such features as bandwidth, pitch, brightness, loudness, and MFCC coefficients. It has problems relating to the cost of the match algorithm (which requires summed differences across the entire feature vector set), as well as the discrimination potential inherent in its feature bank. Many common signal distortions that are encountered in compressed audio files, such as normalization, impact those features, making them unacceptable for a large-scale system. Additionally, it is not tunable for speed versus robustness, which is an important trait for certain systems.

U.S. Pat. No. 5,581,658 describes a system which uses neural networks to identify audio content. It has advantages in high noise situations versus feature vector based systems, but does not scale effectively, due to the cost of running a neural network to discriminate between hundreds of thousands, and potentially millions of signal patterns, making it impractical for a large-scale system.

U.S. Pat. No. 5,210,820 describes an earlier form of feature vector analysis, which uses a simple spectral band analysis, with statistical measures such as variance, moments, and kurtosis calculations applied. It proves to be effective at recognizing audio signals after common radio style distortions, such as speed and volume shifts, but tends to break down under psycho-acoustic compression schemes such as mp3 and ogg vorbis, or other high noise situations.

None of these systems proves to be scalable to a large number of fingerprints, and a large volume of recognition requests. Additionally, none of the existing systems are effectively able to deal with many of the common types of signal distortion encountered with compressed files, such as normalization, small amounts of time compression and expansion, envelope changes, noise injection, and psycho acoustic compression artifacts.

### SUMMARY OF THE INVENTION

This system for acoustic fingerprinting consists of two parts: the fingerprint generation component, and the fingerprint recognition component. Fingerprints are built off a sound stream, which may be sourced from a compressed audio file, a CD, a radio broadcast, or any of the available digital audio sources. Depending on whether a defined start point exists in the audio stream, a different fingerprint variant may be used. The recognition component can exist on the same computer as the fingerprint component, but will frequently be located on a central server, where multiple fingerprint sources can access it.

Fingerprints are formed by the subdivision of an audio stream into discrete frames, wherein acoustic features, such as zero crossing rates, spectral residuals, and Haar wavelet residuals are extracted, summarized, and organized into frame feature vectors. Depending on the robustness requirement of an application, different frame overlap percentages, and summarization methods are supported, including simple frame vector concatenation, statistical summary (such as variance, mean, first derivative, and moment calculation), and frame vector aggregation.

Fingerprint recognition is performed by a Manhattan distance calculation between a nearest neighbor set of feature vectors (or alternatvely, via a multiresolution distance calculation), from a reference database of feature vectors, and a given unknown fingerprint vector. Additionally, previously unknown fingerprints can be recognized due to a lack of similarity with existing fingerprints, allowing the system to intelligently index new signals as they are encountered. Identifiers are associated with the reference database vector, which allows the match subsystem to return the associated identifier when a matching reference vector is found.

Finally, comparison functions can be described to allow the direct comparison of fingerprint vectors, for the purpose of defining similarity in specific feature areas, or from a gestalt perspective. This allows the sorting of fingerprint vectors by similarity, a useful quantity for multimedia database systems.

### BRIEF DESCRIPTION OF THE DRAWINGS

The invention will be more readily understood with reference to the following FIGS. wherein like characters represent like components throughout and in which:

FIG. 1 is a logic flow diagram, showing the preprocessing stage of fingerprint generation, including decompression, down sampling, and dc offset correction.

FIG. 2 is a logic flow diagram, giving an overview of the fingerprint generation steps.

FIG. 3 is a logic flow diagram, giving more detail of the time domain feature extraction step.

FIG. 4 is a logic flow diagram, giving more detail of the spectral domain feature extraction step.

FIG. 5 is a logic flow diagram, giving more detail of the beat tracking feature step.

FIG. 6 is a logic flow diagram, giving more detail of the finalization step, including spectral band residual computation, and wavelet residual computation and sorting.

FIG. 7 is a diagram of the aggregation match server components.

FIG. 8 is a diagram of the collection match server components.

FIG. 9 is a logic flow diagram, giving an overview of the concatenation match server logic.

FIG. 10 is a logic flow diagram, giving more detail of the concatenation match server comparison function.

FIG. 11 is a logic flow diagram, giving an overview of the aggregation match server logic.

FIG. 12 is a logic flow diagram, giving more detail of the aggregation match server string fingerprint comparison function.

FIG. 13 is a simplified logic flow diagram of a meta-cleansing technique of the present invention.

### DETAILED DESCRIPTION OF THE INVENTION

The ideal context of this system places the fingerprint generation component within a database or media playback tool. This system, upon adding unknown content, proceeds to generate a fingerprint, which is then sent to the fingerprint recognition component, located on a central recognition server. The resulting identification information can then be returned to the media playback tool, allowing, for example, the correct identification of an unknown piece of music, or the tracking of royalty payments by the playback tool.

The first step in generating a fingerprint is accessing a file. As used herein, “accessing” means opening, downloading, copying, listening to, viewing (for example in the case of a video file), displaying, running (for example in the case of a software file) or otherwise using a file. Some aspects of the present invention are applicable only to audio files, whereas other aspects are applicable to audio files and other types of files. The preferred embodiment, and the description which follows, relate to a digital file representing an audio file.

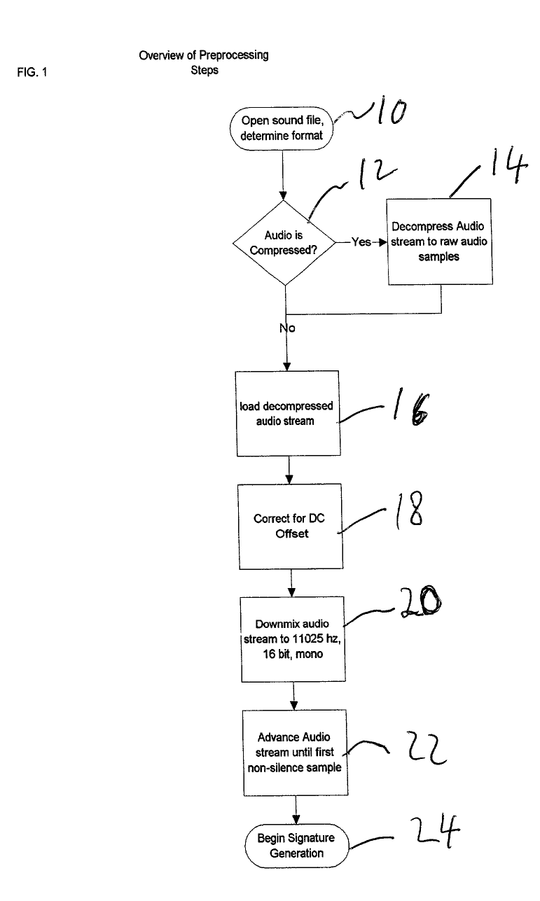

The first step of accessing a file is the opening of a media file in block 10 of FIG. 1. The file format is identified. Block 12 tests for compression. If the file is compressed, block 14 decompresses the audio stream.

The decompressed audio stream is loaded at block 16. The decompressed stream is then scanned for a DC offset error at block 18, and if one is detected, the offset is removed. Following the DC offset correction, the audio stream is down sampled to 11025 hz at block 20, which also serves as a low pass filter of the high frequency component of the audio, and is then down mixed to a mono stream, since the current feature banks do not rely upon phase information. This step is performed to both speed up extraction of acoustic features, and because more noise is introduced in high frequency components by compression and radio broadcast, making them less useful components from a feature standpoint. At block 22, this audio stream is advanced until the first non-slient sample. This 11025 hz, 16 bit, mono audio stream is then passed into the fingerprint generation subsystem for the beginning of signature or fingerprint generation at block 24.

Four parameters influence fingerprint generation, specifically, frame size, frame overlap percentage, frame vector aggregation type, and signal sample length. In different types of applications, these can be optimized to meet a particular need. For example, increasing the signal sample length will audit a larger amount of a signal, which makes the system usable for signal quality assurance, but takes longer to generate a fingerprint. Increasing the frame size decreases the fingerprint generation cost, reduces the data rate of the final signature, and makes the system more robust to small misalignment in fingerprint windows, but reduces the overall robustness of the fingerprint. Increasing the frame overlap percentage increases the robustness of the fingerprint, reduces sensitivity to window misalignment, and can remove the need to sample a fingerprint from a known start point, when a high overlap percentage is coupled with a collection style frame aggregation method. It has the costs of a higher data rate for the fingerprint, longer fingerprint generation times, and a more expensive match routine.

In the present invention, 2 combinations of parameters were found to be particularly effective for different systems. The use of a frame size of 96,000 samples, a frame overlap percentage of 0, a concatenation frame vector aggregation method, and a signal sample length of 288,000 samples proves very effective at quickly indexing multimedia content, based on sampling the first 26 seconds in each file. It is not robust against window shifting, or usable in a system wherein that window cannot be aligned, however. In other words, this technique works where the starting point for the audio stream is known.

For applications where the overlap point between a reference fingerprint and an audio stream is unknown (i.e., the starting point is not known), the use of 32,000 sample frame windows, with a 75% frame overlap, a signal sample length equal to the entire audio stream, and a collection aggregation method is advised. The frame overlap of 75 percent means that a frame overlaps an adjacent frame by 75 percent.

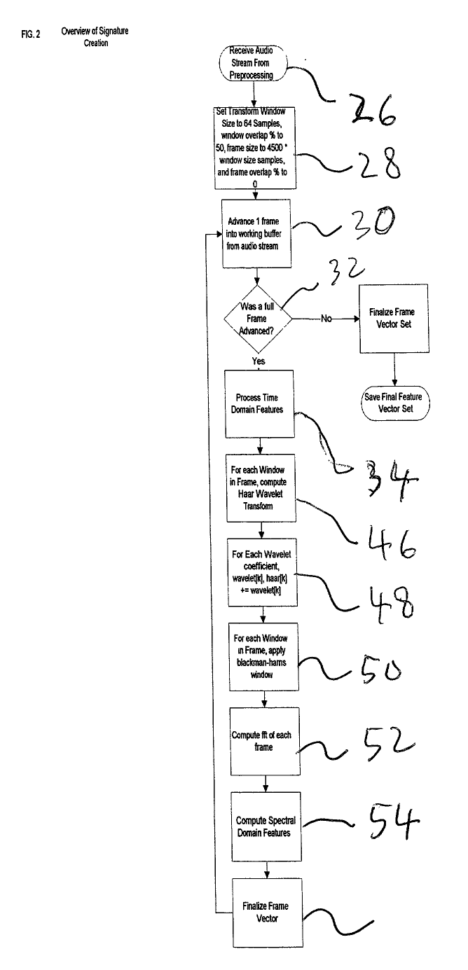

Turning now to the fingerprint pipeline of FIG. 2, the audio stream is received at block 26 from the preprocessing technique of FIG. 1. At block 28, the transform window size is set to 64 samples, the window overlap percentage is set (to zero in this case), frame size is set to 4500 window size samples. At block 30, the next step is to advance window frame size samples into the working buffer.

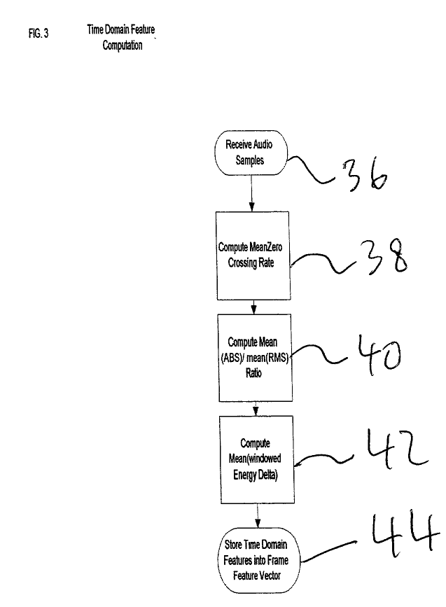

Block 32 tests if a full frame was read in. If so, the time domain features of the working frame vector are computed at block 34 of FIG. 2. This is done using the steps now described with reference to FIG. 3. After receiving the audio samples at block 36, the zero crossing rate is computed at block 38 by storing the sign of the previous sample, and incrementing a counter each time the sign of the current sample is not equal to the sign of the previous sample, with zero samples ignored. The zero crossing total is then divided by the frame window length, to compute the zero crossing mean feature. The absolute value of each sample is also summed into a temporary variable, which is also divided by the frame window length to compute the sample mean value. This is divided by the root-mean-square of the samples in the frame window, to compute the mean/RMS ratio feature at block 40. Additionally, the mean energy value is stored for each block of 10624 samples within the frame. The absolute value of the difference from block to block is then averaged to compute the mean energy delta feature at block 42. These features are then stored in a frame feature vector at block 44.

Having completed the detailed explanation of the block 34 of FIG. 2 as shown at FIG. 3, reference is made back to FIG. 2 where the process continues at block 46. At this block, a Haar wavelet transform, with transform size of 64 samples, using 1/2 for the high pass and low pass components of the transform, is computed across the frame samples. Each transform is overlapped by 50%, and the resulting coefficients are summed into a 64 point array. Each point in the array is then divided by the number of transforms that have been performed, and the minimum array value is stored as the normalization value. The absolute value of each array value minus the normalization value is then stored in the array, any values less than 1 are set to 0, and the final array values are converted to log space using the equation array[I]=20*log10 (array[I]). These log scaled values are then sorted into ascending order, to create the wavelet domain feature bank at block 48.

Subsequent to the wavelet computation, a Blackman-Harris window of 64 samples in length is applied at block 50, and a Fast Fourier transform is computed at block 52. The resulting power bands are summed in a 32 point array, converted to a log scale using the equation spec[I]=log10(spec[I]/4096)+6, and then the difference from the previous transform is summed in a companion spectral band delta array of 32 points. This is repeated, with a 50% overlap between each transform, across the entire frame window. Additionally, after each transform is converted to log scale, the sum of the second and third bands, times 5, is stored in an array, beatStore, indexed by the transform number.

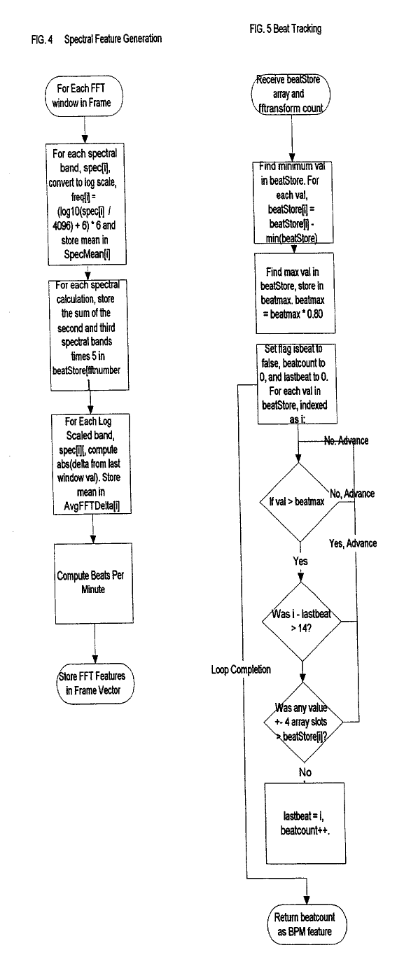

After the calculation of the last Fourier transform, the spectral domain features are computed at block 54. More specifically, this corresponds to FIGS. 4 and 5. The beatStore array is processed using the beat tracking algorithm described in FIG. 5. The minimum value in the beatStore array is found, and each beatStore value is adjusted such that beatStore[I]=beatStore[I]−minimum val. Then, the maximum value in the beatStore array is found, and a constant, beatmax is declared which is 80% of the maximum value in the beatStore array. For each value in the beatStore array which is greater than the beatmax constant, if all the beatStore values +−4 array slots are less than the current value, and it has been more than 14 slots since the last detected beat, a beat is detected and the BPM feature is incremented.

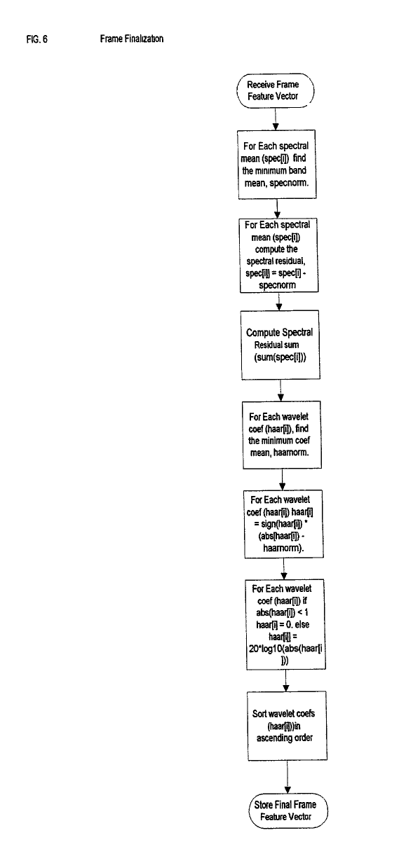

Upon completing the spectral domain calculations, the frame finalization process described in FIG. 6 is used to cleanup the final frame feature values. First, the spectral power band means are converted to spectral residual bands by finding the minimum spectral band mean, and subtracting it from each spectral band mean. Next the sum of the spectral residuals is stored as the spectral residual sum feature. Finally, depending on the aggregation type, the final frame vector consisting of the spectral residuals, the spectral deltas, the sorted wavelet residuals, the beats feature, the mean/RMS ratio, the zero crossing rate, and the mean energy delta feature is stored. In the concatenation model, the frame vector is concatenated with any other frame vectors to form a final fingerprint vector. In the aggregation model, each frame vector is stored in a final fingerprint set, where each vector is kept separate.

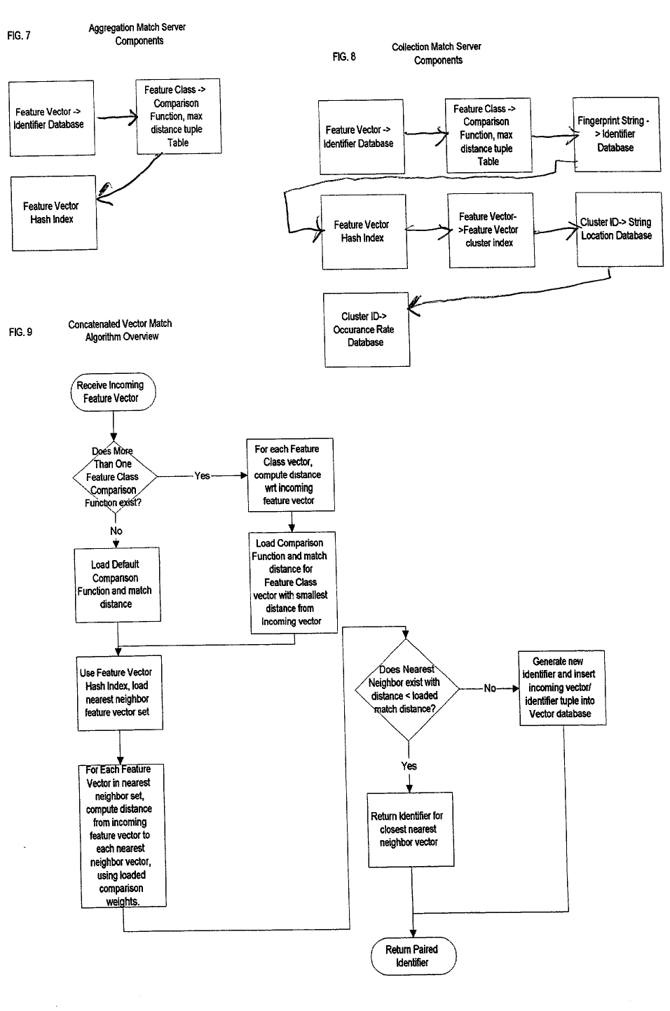

In the preferred system, the fingerprint resolution component is located on a central server, although methods using a partitioning scheme based on the fingerprint database hash tables can also be used in a distributed system. Depending on the type of fingerprint to be resolved, the architecture of the server will be similar to FIG. 7 for concatenation model fingerprints, and similar to FIG. 8 for aggregation style fingerprints. Both models share several data tables, such as the feature vector→identifier database, the feature vector hash index, and the feature class→comparison weights and match distance tuple table. Within the concatenation system, the identifiers in the feature vector→identifier database are unique GUIDs, which allows the return of a unique identifier for an identified fingerprint. The aggregation match server has several additional tables. The cluster ID occurrence rate table shows the overall occurrence rate of any given feature vector, for the probability functions within the match algorithm. The feature vector cluster table is a mapping from any feature vector to the cluster ID which identifies all the nearest neighbor feature vectors for a given feature vector. In the aggregation system, a unique integer or similar value is used in place of the GUID, since the Fingerprint String database contains the GUID for aggregation fingerprints. The fingerprint string database consists of the identifier streams associated with a given fingerprint, and the cluster ID's for each component within the identifier stream. Finally, the cluster ID→string location table consists of a mapping between every cluster ID and all the string fingerprints that contain a given cluster ID.

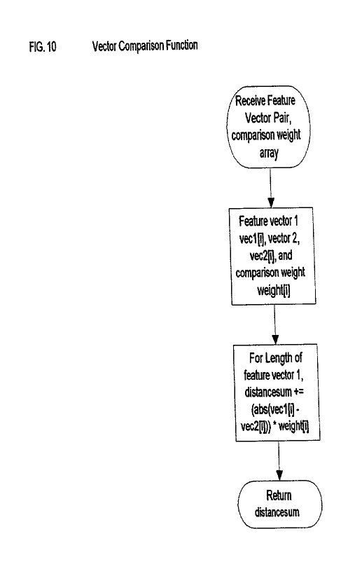

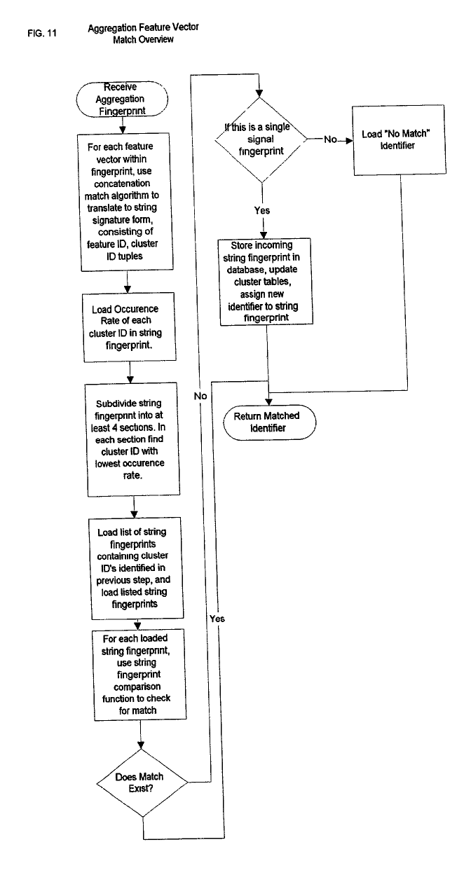

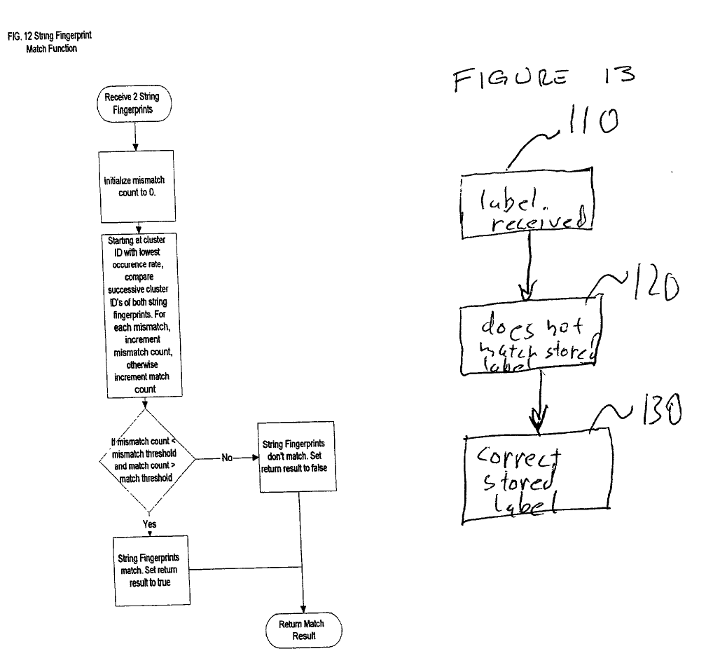

To resolve an incoming concatenation fingerprint, the match algorithm described in FIG. 9 is used. First, a check is performed to see if more than one feature class exists, and if so, the incoming feature vector is compared against each reference class vector, using the comparison function in FIG. 10 and a default weight set. The feature class with the shortest distance to the incoming feature vector is used to load an associated comparison function weight scheme and match distance. Next, using the feature vector database hash index, which subdivides the reference feature vector database based on the highest weighted features in the vector, the nearest neighbor feature vector set of the incoming feature vector is loaded. Next, each loaded feature vector in the nearest neighbor set is compared, using the loaded comparison weight scheme. If any of the reference vectors have a distance less than the loaded match threshold, the linked GUID for that reference vector is returned as the match for the incoming feature vector. If none of the nearest neighbor vectors are within the match threshold, a new GUID is generated, and the incoming feature vector is added to the reference database, allowing the system to organically add to the reference database as signals are encountered. Additionally, the step of re-averaging the feature values of the matched feature vector can be taken, which consists of multiplying each feature vector field by the number of times it has been matched, adding the values of the incoming feature vector, dividing by the now incremented match count, and storing the resulting means in the reference database entry. This helps to reduce fencepost error, and move a reference feature vector to the center of the spread for different quality observations of a signal, in the event the initial observations were of an overly high or low quality.

Resolution of an aggregation fingerprint is essentially a two level process. First, the individual feature vectors within the aggregation fingerprint are resolved, using essentially the same process as the concatenation fingerprint, with the modification that instead of returning a GUID, the individual signatures return a subsig ID and a cluster ID, which indicates the nearest neighbor set that a given subsig belongs to. After all the aggregated feature vectors within the fingerprint are resolved, a string fingerprint, consisting of an array of subsig ID and cluster ID tuples is formed. This format allows for the recognition of signal patterns within a larger signal stream, as well as the detection of a signal that has been reversed. Matching is performed by subdividing the incoming string fingerprint into smaller chunks, such as the subsigs which correspond to 10 seconds of a signal, looking up which cluster ID within that window has the lowest occurrence rate in the overall feature database, loading the reference string fingerprints which share that cluster ID, and doing a run length match between those loaded string fingerprints and the incoming fingerprint. Additionally, the number of matches and mismatches between the reference string fingerprint and the incoming fingerprint are stored. This is used instead of summed distances, because several consecutive mismatches should trigger a mismatch, since that indicates a strong difference in the signals between two fingerprints. Finally, if the match vs. mismatch rate crosses a predefined threshold, a match is recognized, and the GUID associated with the matched string fingerprint is returned.

Additional variants on this match routine include searching forwards and backwards for matches, so as to detect reversed signals, and accepting a continuous stream of aggregation feature vectors, storing a trailing window, such as 30 seconds of signal, and only returning a GUID when a match is finally detected, advancing the search window as more fingerprint subsigs are submitted to the server. This last variant is particularly useful for a streaming situation, where the start and stop points of the signal to be identified are unknown.

With reference to FIG. 13, a meta-cleansing data aspect of the present invention will be briefly explained. Suppose an Internet user downloads a file at block 110 that is labeled as song A of artist X. However, the database matches the fingerprint to a file labeled as song B of artist Y such that the labels (i.e., in database and to file being accessed) do not match, block 120 thus indicating the difference. Block 130 would then correct the stored labels if appropriate. For example, the database could indicate that the most recent five downloads have labeled this as song A of artist X. Block 130 would then change the stored data such that the label corresponding to the file now is song A of artist X.

Although specific constructions have been presented, it is to be understood that these are for illustrative purposes only. Various modifications and adaptations will be apparent to those of skill in the art. Therefore, the scope of the present invention should be determined by reference to the claims.

What is claimed is:

1. A method of keeping track of access to digital files, the steps comprising:
accessing a digital file;
determining a fingerprint for the file, the fingerprint representing one or more features of the file;
comparing the fingerprint for the file to file fingerprints stored in a file database, the file fingerprints uniquely identifying a corresponding digital file and having a corresponding unique identifier stored in the database;
upon the comparing step revealing a match between the fingerprint for the file and a stored fingerprint, outputting the corresponding unique identifier for the corresponding digital file; and
upon the comparing step revealing no match between the fingerprint for the file and a stored fingerprint, storing the fingerprint in the database, generating a new unique identifier for the file, and storing the new unique identifier for the file.

2. The method of claim 1 wherein the digital files represent sound files.

3. The method of claim 2 wherein the digital files represent music files.

4. The method of claim 3 wherein the features represented by the fingerprint include features selected from the group consisting of:
spectral residuals; and
transforms of Haar wavelets.

5. The method of claim 4 wherein the features represented by the fingerprint include spectral residuals and transforms of Haar wavelets.

6. The method of claim 1 wherein the step of determining the fingerprint of the file includes generating time frames for the file and determining file features within the time frames.

7. A method of keeping track of access to digital files, the steps comprising:
accessing a digital file;
determining a fingerprint for the file, the fingerprint representing one or more features of the file, the features include features selected from the group consisting of:
spectral residuals; and
transforms of Haar wavelets;
comparing the fingerprint for the file to file fingerprints stored in a file database, the file fingerprints uniquely identifying a corresponding digital file and having a corresponding unique identifier stored in the database;
upon the comparing step revealing a match between the fingerprint for the file and a stored fingerprint, outputting the corresponding unique identifier for the corresponding digital file.

8. The method claim 7 wherein the digital files represent sound files.

9. The method claim 7 wherein the digital files represent music files.

10. The method of claim 9 further comprising the step of:
upon the comparing step revealing no match between the fingerprint for the file and a stored fingerprint, storing the fingerprint in the database, generating a new unique identifier for the file, and storing the new unique identifier for the file.

11. The method of claim 10 wherein the features represented by the fingerprint include spectral residuals and transforms of Haar wavelets.

12. The method of claim 7 wherein the features represented by the fingerprint include spectral residuals and transforms of Haar wavelets.

13. A method of keeping track of access to digital files, the steps comprising:
accessing a digital file;
determining a fingerprint for the file, the fingerprint representing one or more features of the file;
comparing the fingerprint for the file to file fingerprints stored in a file database, the file fingerprints uniquely identifying a corresponding digital file and having a corresponding unique identifier stored in the database;
upon the comparing step revealing a match between the fingerprint for the file and a stored fingerprint, outputting the corresponding unique identifier for the corresponding digital file; and storing any label applied to the file; and
automatically correcting a label applied to a file if subsequent accesses to the file show that the label first applied to the file is likely incorrect.
